(19) United States
(12) Patent Application Publication
(10) Pub. No.: US 2008/0025348 A1
(43) Pub. Date: Jan. 31, 2008

(54) High energy, ultrashort pulse ring fiber laser having a linear dispersion compensator with chirped Bragg gratings

(76) Inventors: Dmitri Vladislavovich Kuksenkov, Painted Post, NY (US); Shenping Li, Painted Post, NY (US)

Correspondence Address: CORNING INCORPORATED, SP-TI-3-1, CORNING, NY, 14831, US

(21) Appl. No.: 11/495,204

(22) Filed: Jul. 28, 2006

(51) Int. Cl. H01S 3/30

(52) U.S. Cl. 372/6

(57) ABSTRACT

A high energy, ultra short pulse ring fiber laser is provided that includes a passively mode locked, all optical fiber laser formed from a closed loop of optical fiber doped with erbium or other rare earth metal, a pump light source optically coupled to the loop of optical fiber, and a linear dispersion compensator that includes a pair of chirped Bragg gratings with substantially equal but opposite sign dispersion. The difference in dispersion between the pair of chirped Bragg gratings is adjusted so that it is substantially equal and opposite to the dispersion generated in the loop of optical fiber. The linear dispersion compensator includes a tuner which can individually stretch or compress the pair of chirped fiber Bragg gratings such that one of the gratings can be adjusted to cancel out the dispersion of the ring laser cavity, while the other grating is adjusted to eliminate third order dispersion of the cavity.

### BACKGROUND OF THE INVENTION

1. Field of the Invention

This invention generally relates to high energy, ultrashort pulse lasers, and is specifically concerned with a passively mode-locked, all optical ring fiber laser having a linear dispersion compensator that utilizes at least one chirped fiber Bragg grating.

2. Description of the Related Art

Mode-locked, high energy lasers capable of generating femtosecond pulses are known in the prior art. In one such prior art design, lasing is accomplished by means of a titanium doped sapphire crystal, and a Kerr lens mode-locking operation is implemented by a combination of lenses, diffraction gratings, and prisms. However, such sapphire-based designs tend to be unstable in operation and relatively large and bulky to implement.

Mode-locked fiber lasers for generating ultrashort pulses are also known, and offer an attractive alternative to sapphire or other solid-state laser designs due to their greater operational stability, and more compact size. Unfortunately, the power output of the pulse energy generated by such mode-locked fiber lasers has been generally lower than the pulse power available with sapphire or other solid-state laser designs.

One way to increase the pulse energy of such mode-locked fiber lasers is to use a longer fiber lasing cavity. Such an approach reduces the pulse repetition rate, which, for a fixed average power, increases the energy per pulse. However, long fiber cavities create large nonlinearities in the fiber. Such large nonlinearities limit the pulse energy through two mechanisms including (1) soliton dynamics (i.e., the breakup of the pulses through sideband generation of a periodically perturbed soliton) in the anomalous dispersion fiber used in such fiber lasers, and (2) overdriving of the nonlinear polarization evolution (NPE) commonly used as a mode-locking mechanism in such lasers.

To overcome the limitation of soliton dynamics, stretched-pulse fiber laser designs have been proposed. In such a design, the fiber laser cavity consist of two segments: one segment having large anomalous-dispersion, and another segment having large normal-dispersion, such that the total dispersion of the fiber defining the lasing cavity is kept small and normal in order to avoid the soliton effect. Since the pulse circulating in the ring shaped lasing cavity is alternatively stretched and compressed as the pulses circulate, the average intracavity peak power is reduced. Therefore, higher pulse energy may be achieved. Unfortunately, the soliton dynamics in the anomalous dispersion fiber still remains a limitation for further increase of the pulse energy. To solve this problem, some prior art designs have replaced the anomalous dispersion fiber with bulk, non-fiber optical components, such as gratings and prisms, in order to form a dispersion compensator. While such a design achieves the objective of higher pulse energy, it does so at the expense of losing the main advantages associated with such all-fiber laser designs, i.e., compact size and freedom from misalignment.

Accordingly, there is a need for a mode-locked, all-fiber laser capable of generating high energy, ultrashort pulses without the need for bulk optics which disadvantageously increases the size of the laser, and further provides the potential for misalignment problems. Ideally, such a high energy, ultrashort pulse laser should be formed from all-fiber components which are relatively easy and inexpensive to manufacture, and readily assembled. Finally, the resulting all-fiber laser should be self-starting, passively mode-locking, and highly stable in operation.

### SUMMARY OF THE INVENTION

Generally speaking, the invention is a high energy, ultrashort pulse fiber laser that overcomes all of the aforementioned shortcomings while preserving the principal advantages of compact size and freedom of misalignment. To this end, the pulse fiber laser of the invention a passively mode locked, all optical fiber laser including a closed loop of optical fiber doped with a gain-providing material (such as erbium) that defines a ring-shaped lasing cavity, a pump-light source optically coupled to the closed loop of optical fiber, and a linear dispersion compensator including at least one chirped fiber Bragg grating. Preferably, the linear dispersion compensator includes a pair of chirped fiber Bragg gratings with opposite sign dispersion optically coupled to the loop of optical fiber such that a net difference in dispersion between the first and second fiber Bragg gratings is substantially equal and opposite to dispersion generated in the loop of optical fiber.

The linear dispersion compensator may also include a four-port, polarization-maintaining optical circulator for optically coupling the pair of chirped fiber Bragg gratings to the fiber ring lasing cavity. The compensator also preferably includes a tuner for varying the band width or dispersion generated by the chirped Bragg fiber gratings to adjust a net dispersion of the ring laser cavity, and a third order dispersion of the cavity in order to optimize the energy of the pulses. The tuner may include a mechanism for selectively stretching and compressing each of the chirped fiber Bragg gratings in such a fashion that the first Bragg grating adjusts the net dispersion of the ring laser cavity, while the second Bragg grating adjusts third-order dispersion of the cavity.

The fiber laser of the invention further may include a polarization controller optically coupled to the loop of optical fiber for passively mode locking the optical fiber ring lasing cavity. While the polarization controller may assume many forms, an electrically operated fiber-optic polarization controller is preferred due to its ability to automatically achieve mode-locking in fiber lasers.

The use of chirped fiber Bragg gratings as a linear dispersion compensator allows the laser to have an all-fiber architecture, thereby preserving the compact size and freedom from misalignment that fiber lasers offer. Moreover, the use of a pair of serially connected fiber Bragg gratings having substantially equal and opposite dispersions, in combination with a tuner that allows each grating to be individually stretched or compressed, provides a linear dispersion compensator capable of easily adjusting both the net dispersion of the ring laser cavity and the third order dispersion of the cavity to optimize the energy of the pulses.

### DESCRIPTION OF THE DRAWINGS

FIG. 1 is a schematic diagram of a high energy, ultrashort pulse fiber laser having a linear dispersion compensator in accordance with the invention;

FIG. 2 is a graph illustrating how the dispersion of the optical fiber defining the laser cavity increases with cavity length for both an operating wavelength of (a) 1550 nm and an operating wavelength of (b) 1060 nm;

FIG. 3 illustrates how the dispersion of the linear dispersion compensator of the invention varies with changes in the spectral band-width of one of the chirped fiber Bragg ratings used in the compensator for a wavelengths of (a) 1550 nm and (b) 1060 nm, respectively;

FIGS. 4A and 4B are graphs of experimental results of the autocorrelation trace and spectrum of the output pulses of a ring fiber laser embodying the invention, respectively;

FIGS. 5A and 5B are recorded waveforms of pulses generated by a ring fiber laser embodying the invention for scales of 10 ns per division on the horizontal axis, respectively, and

FIG. 6 is a graph of a family of curves illustrating autocorrelation traces of output pulses of a ring fiber laser embodying the invention for different settings of the CFBGs of the dispersion compensator.

### DETAILED DESCRIPTION OF THE PREFERRED EMBODIMENT

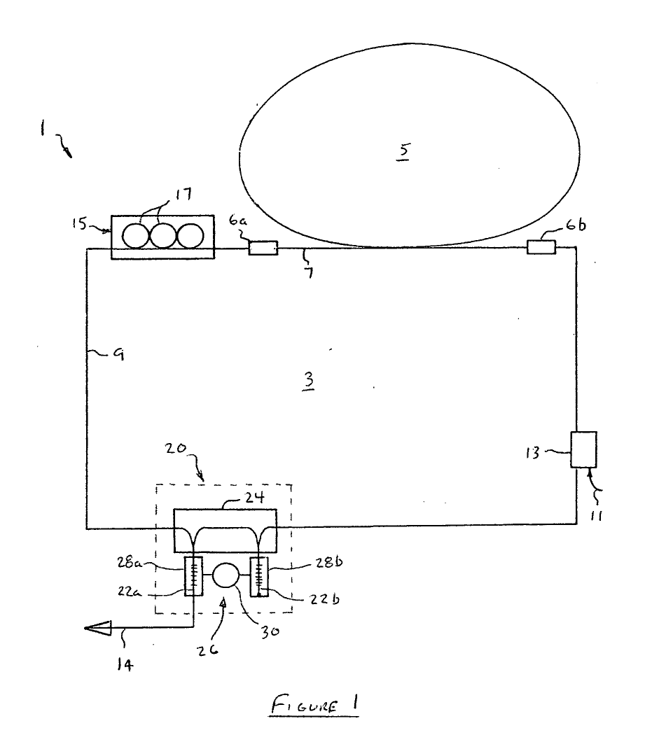

With reference now to FIG. 1, the high energy, ultrashort pulse fiber laser 1 of the invention consist of a single closed circuit 3 of optical fiber that includes a gain loop 5 connected to the balance of the optical fiber circuit 3 via splices 6a and 6b. The gain loop 5 is formed from a length of optical fiber doped with a gain-producing material. In this particular example, the gain loop 5 is a segment of optical fiber approximately 5 meters long that has been doped with erbium at a concentration of 1700 ppm, although other dopents (such as ytterbium or other rare earth metals) may also be used. Such a length of erbium-doped optical fiber has a dispersion of β₂=38.5 ps²/km, which gives the 5 meter length a total positive dispersion of about 0.193 ps². Other lengths of doped optical fiber may be used to form the gain loop 5. However, the length of optical fiber should be no less than about 2 meters in order to provide a sufficiently long laser cavity to produce the desired high-energy ultrashort pulses, and no longer than about 20 meters to avoid undesirable instabilities in the resulting fiber laser. The absorption of the 5 meter gain loop 5 at a wavelength of 980 nm is 9.2 dB/m, while the mean fiber diameter of the optical fiber is 5.66 μm. The gain loop 5 forms a positive dispersion segment 7 of the circuit 3 having the previously mentioned total positive dispersion of 0.19 ps². The balance of the circuit 3 forms a negative dispersion segment 9 that includes about 2 meters of passive, undoped optical fiber having an estimated total dispersion of −0.085 ps². Hence, the net dispersion of the circuit 3 of optical fiber forming the ring laser cavity is about 0.105 ps² which, as will be discussed in more detail hereinafter, must be zeroed-out by the linear dispersion compensator 20 in the circuit 3 in order to optimize the energy of the generated pulses. While it would be possible to increase the length of the negative dispersion segment 9 relative to the erbium-doped, positive dispersion segment 7 in order to reduce the net dispersion present in the overall fiber optic circuit 3, such balancing is not necessary as the linear dispersion compensator 20 is capable of zeroing-out the net dispersion of any type or length of fiber used in the laser 1 of the invention.

The laser 1 further includes an input comprising a pump laser source 11 having a wavelength of, for example, 980 nm or 1460 nm. Laser source 11 is coupled to the optical fiber circuit 3 via a wave division multiplexer 13 as shown. An output fiber 14 extends out of the linear dispersion compensator 20 as shown, and provides a tap for the high energy pulses generated by the laser 1.

A polarization controller 15 is also provided within the optical fiber circuit 3. Polarization controller 15 includes 3 control coils 17 which may be twisted relative to the axis of the segment 9, and to each other, in order to control the polarization angle of the light circulating through this circuit 3. By properly adjusting the polarization controller 15, the laser 1 can be made to be self-starting, and mode-locking. While a loop-type polarization controller 15 is used in the preferred embodiment 1, any type of all-fiber polarization controller may be used in the context of the invention.

Finally, the laser 1 includes a linear dispersion compensator 20. Compensator 20 includes a pair of chirped fiber Bragg gratings 22a, 22b connected in series via a four-port optical circulator 24. The two chirped fiber Bragg gratings 22a, 22b have opposite and substantially equal dispersion. In the preferred embodiment which is operated with a pump wavelength of 980 nm or 1460 nm, these gratings 22a, 22b have a same bandwidth of 20 nm and a same grating length of 10 mm and thus have the same chirp. The reflectivities of the two gratings 22a, 22b are 50% and 90%, respectively. The long wavelength side of the first grating 22a and short wavelength side of the second grating 22b are connected to the circulator 24.

The compensator 20 further includes a tuner 26 for providing some degree of adjustability with respect to the amount of compensating dispersion that the compensator 20 generates. The tuner includes mechanisms 28a, 28b for stretching and compressing the chirped fiber Bragg gratings 22a, 22b, respectively. In the preferred embodiment, mechanisms 28a, 28b each comprise a length of flexible fiberglass to which the gratings 22a and 22b are glued to via an epoxy cement or other appropriate adhesive. The lengths of flexible fiberglass are arranged over a fulcrum, and a thumbscrew (not shown) is arranged to bend the length of fiberglass a desired amount around the fulcrum. Bending the fiberglass that the gratings 22a, 22b are adhered to of course tends to lengthen them, while relaxing the thumbscrew in order to allow the fiberglass to resume its unbent shape shortens them. While such a bending assembly forms the stretching and compressing mechanisms 28a, 28b of the preferred embodiment, these mechanisms may also be implemented by way of piezoelectric crystals (which change their axial length proportional to an amount of electric current conducted through them), or by metalizing the gratings 22a, 22b with a metal having a particularly high degree of thermal differential expansion and by heating or cooling the metal-coated gratings. All such mechanisms are within the scope of the invention. Finally, the linear dispersion compensator 20 includes a controller 30 that regulates the specific amount of stretching or compression that the mechanisms 28a, 28b apply to the gratings 22a, 22b. As previously mentioned, the controller 30 in the preferred embodiment is a simple thumbscrew that bends the fiberglass to which the gratings are adhered to in a desired amount over a fulcrum. The form the controller takes will, of course, be dependent upon the form that the stretching and compressing mechanisms 28a, 28b take.

During operation of the laser 1, the linear dispersion compensator 20 performs four distinct functions. First and most importantly, adjustment of the tuner 26 of the compensator 20 causes the compensator 20 to generate a compensating dispersion in the circuit 3 of optical fiber that defines the ring-shaped lasing cavity, allowing the pulses generated therein to obtain a maximum energy level without pulse splitting caused by the sideband generation of a periodically perturbed soliton. The compensating dispersion generated by the compensator 20 causes the pulses circulating throughout the circuit 3 to be alternatively stretched and compressed, thereby reducing the average intra-cavity peak power. This allows a higher pulse energy to be achieved. However, in addition providing compensating dispersion to the dispersion present in the circuit 3, the compensator 20 provides a narrow band pass filter as well as an optical isolator for achieving unidirectional lasing in the ring-shaped lasing cavity, both of which advantageously serve to stabilize the lasing operation. Finally, the four-port optical circulator 24 also polarizes the light conducted through the optical fiber circuit 3, complementing the function of the polarization controller 15.

The preferred method of adjusting the compensating dispersion of the compensator 20 is to operate one of the stretching and compressing mechanisms 28a, 28b, to stretch or compress only one of the chirped fiber Bragg gratings while the other one remains unadjusted. This step adjusts the amount of dispersion generated by the stretched or compressed grating, and hence adjusts the net difference between the dispersions generated by the two gratings 22a, 22b, which is adjusted to be equal and opposite in sign to the net dispersion of the positive and negative segments 7, 9 of the fiber laser 1. Once this step is completed, the unadjusted chirped fiber grating is then either stretched or compressed in order to minimize the third order dispersion of the ring-shaped cavity defined by the optical fiber circuit 3 to optimize the energy of the resulting pulses.

FIG. 2 discloses how the dispersion of the compensator 20 changes with respect to the change of the spectral bandwidth of one of the chirped fiber Bragg gratings for wavelengths of 1550 nm and 1060 nm, respectively. In these graphs, the length of the chirped fiber Bragg gratings is 20 mm. The original bandwidth of the grating is 17.64 nm for the 1550 nm wavelength and 8.26 nm for the 1060 nm wavelength.

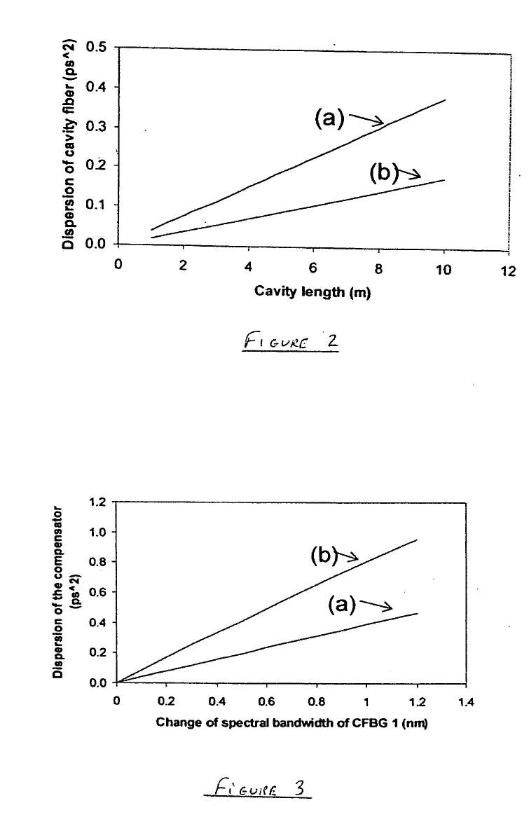

FIG. 3 illustrates the dispersion of the cavity fiber as a function of cavity length for wavelengths of 1550 nm and 1060 nm. The dispersion parameter of the fiber is assumed to be −30 ps/nm-km for both cases. The graph illustrates that the linear dispersion compensator 20 must generally provide a greater amount of compensating dispersion for optical fiber circuits 3 of greater lengths.

The operation and advantages of the laser 1 of the invention will now be described with reference to FIGS. 2 and 3.

To avoid pulse splitting from the previously mentioned soliton effects, the laser cavity defined by the circuit 3 of optical fiber should have net normal dispersion. Hence, the total dispersion of the linear dispersion compensator 20 must be smaller than the total dispersion of the part of the laser cavity with normal dispersion.

The dispersion of fiber with a length of L can be expressed as

$${β}_{f} = {β}_{2} L = - \frac{{λ}^{2} DL}{2 π c}$$

where D is the dispersion parameter of the fiber, c is the light velocity in vacuum, λ is the wavelength. On the other hand, the dispersion of a linearly chirped fiber Bragg grating (CFBG) with a length of L_{g} can be written as

$${β}_{g} = - \frac{n {λ}^{2} {L}_{g}}{2 π {c}^{2} Δ λ}$$

When n is the refractive index of grating fiber, Δλ is the bandwidth of CFBG. From Equations (1) and (2), it is easy possible to obtain the maximum grating length to achieve a cavity with a net normal dispersion in a fiber laser with a CFBG, which is

$${L}_{g - max} = \frac{c Δ {λ}^{2} {DL}_{g}}{2 π}$$

As an example, FIG. 2 shows the maximum length of a CFBG as a function of laser cavity length for operating wavelength of (a) 1550 nm (b) 1060 nm. The dispersion parameter of the cavity fiber is −30 ps/nm-km. The spectral bandwidths of the CFBGs for wavelength 1550 nm and 1060 nm are 17.64 nm and 8.26 nm respectively, which corresponds to the minimal required spectral bandwidth for generating Gaussian shaped pulses with a pulsewidth of 200 fs. To avoid overdriving of the NPE, the cavity length of a stretched-pulse laser is typically a few meters. As shown in FIG. 2, the maximum length of a CFBG is less than 0.55 mm (0.25 mm) for operating wavelength of 1550 nm (1060 nm) for a cavity length less than 10 m. In such a short length, it is almost impossible to make a CFBG with enough bandwidth for generating ultrashort pulses.

The laser 1 of FIG. 1 solves this problem by means of the linear dispersion compensator 20 which includes two CFBGs 22a, 22b with opposite dispersion that are connected to the fiber laser via a four-port optical circulator. The four-port circulator 20 could in principle be replaced by two three-port circulators connected in series, one for each grating, but an integrated design typically has lower insertion loss. The use of two CFBGs 22a, 22b in the compensator 20, in combination with a tuner, allows a range of small amounts of dispersion to be produced by two CFBGs, having easily manufactured dimensions. This can be easily seen from the expression for total dispersion, which can be written as:

$${β}_{gt} = - \frac{n {λ}^{2}}{π {c}^{2}} [ \frac{{L}_{g 1}}{Δ {λ}_{1}} - \frac{{L}_{g 1}}{Δ {λ}_{2}} ]$$

where L_{g1} and L_{g2} are respectively the length of CFBG1 and CFBG2, and Δλ₁ and Δλ₂ are the bandwidths of CFBG1 and CFBG2 respectively. An example is shown in FIG. 2. In this example, the two gratings have the same length of 20 mm. The original bandwidth of the CFBG is 17.64 nm (8.26 nm) for wavelength of 1550 nm (1060 nm). The dispersion of the compensator 20 is tuned by changing the bandwidth (or dispersion) of one of the CFBGs which can be easily achieved by stretching or compressing the CFBG. For comparison, the total dispersion of cavity fiber with a dispersion of −30 ps/nm-km as a function of a cavity length is shown in FIG. 3. It is clearly seen that the net dispersion of the laser cavity can be set at any amount between zero and the total dispersion of the cavity fiber by changing the dispersion of one CFBG. By contrast, if only one CFBG were used to generate the necessary compensation dispersion, it would have a length of only 2 or 3 mm, and would be difficult to manufacture and to adjust. Second, the third order dispersion of the cavity can be minimized by adjusting the other CFBG 22b in order to get high quality pulse. Third, because of short fiber length of CFBGs, the nonlinearity in the fiber of CFBGs is negligible. The optical circulator can be considered as a linear device when its pigtail fiber is considered as a part of the cavity fiber. Fourth, because CFBGs are fiber based and optical circulator is a very compact device and fiber pigtailed, the resulting laser system is very compact, free from misalignment, and environmentally stable. To avoid the pulse splitting due to soliton dynamics in anomalous-dispersion fiber, all fiber in the laser cavity should preferably have normal dispersion.

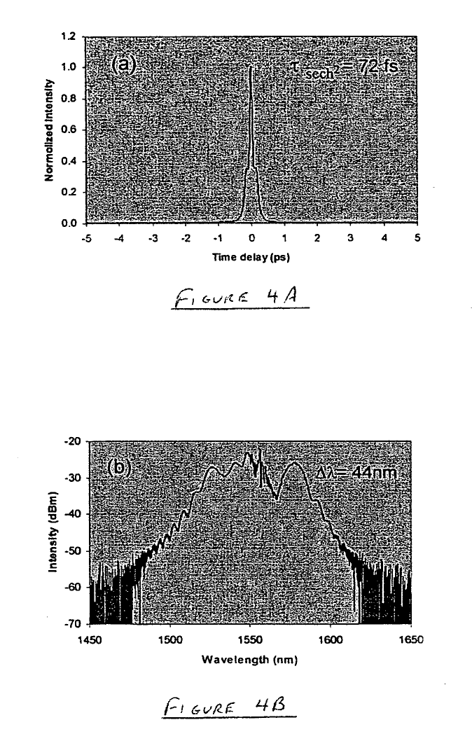

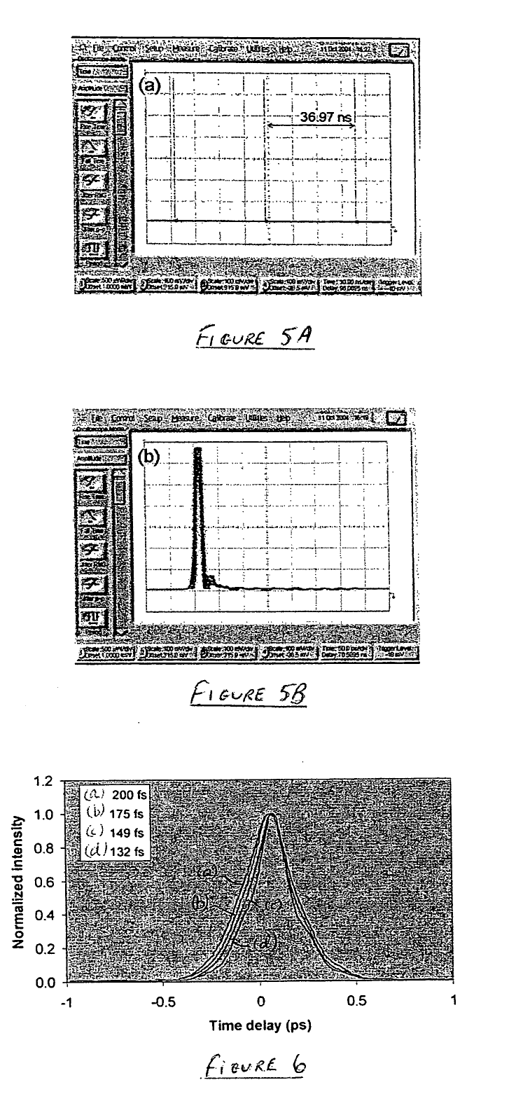

The operation of laser 1 of the invention will now be described with respect to the experimental results obtained by a laser made in conformance with the preferred embodiment previously described. The pump light 11 is first actuated to conduct laser light at a wavelength of, for example, 980 nm around the circuit 3 via the wave division multiplexer 13. Next, the polarization controller 15 is adjusted by twisting the control coil 17 around the segment 9 while monitoring the pulses generated at output 14 until the laser 1 is mode-locked and self-started. Finally, the controller 30 is operated to stretch or compress one or the other of the fiber Bragg gratings 22a, 22b to optimize the energy of the pulses. In the laser 1 of the previously-described preferred embodiment, the measured pulse width is 72 fs by supposing the sech²pulsesharp, as shown in FIG. 4A. The center wavelength of the generated pulses is 1550 nm, and the measured 3 dB spectral width is 44 nm, as shown in FIG. 4B. Thus, a time-bandwidth product of 0.4 is achieved, indicating that the output pulse is nearly transform-limited. To verify single pulse operation of the laser 1 of the preferred embodiment, a combination of a fast detector/sampling scope (<50 ps) and an autocorrelator with a 75 ps scanning range was used to monitor the output pulses. FIGS. 5A and 5B show a typical waveform recorded by a sampling scope for two different time scales. The measured frequency of the waveform was 27.05 MHz, which is agreement with the calculated value from the measured cavity length (which was the combined length of the positive dispersion segment 7 and the negative dispersion segment 9, or about 7.3 m). No multiple pulse lasing was observed in either the autocorrelator or the scope, indicating the laser operated at the fundamental frequency of the cavity. Since the average power of the output pulses was 28.7 mW (with only 980 nm pumping at about 400 mW) a single pulse energy of 1.06 nJ was obtained.

A primary advantage of this laser is that the net cavity dispersion can be continuously tuned by changing the bandwidth (or dispersion) of one of the CFBGs 22a, 22b which can be easily achieved by straining or compressing one (or both) of the CFBGs. Since the chirp (thus pulsewidth) of output pulses depends on the net dispersion of the laser cavity, the change of cavity dispersion can be observed by monitoring the pulsewidth of the output. As an example, FIG. 6 shows the autocorrelation traces of the output pulses for four different settings of the tunable dispersion compensator 20 by compressing CFBG1. It clearly shows that the pulsewidth of the output (or cavity dispersion) can be smoothly adjusted by tuning one or both of the CFBGs 22a, 22b.

What is claimed is:

1. A high energy, ultrashort pulse fiber laser, comprising:
a passively mode locked, all optical fiber ring laser including a loop of optical fiber doped with a material that provides gain that defines a ring lasing cavity;
a pump light source optically coupled to said loop of optical fiber, and
a linear dispersion compensator including at least one chirped Bragg fiber grating optically coupled to said closed loop of optical fiber.

2. The high energy, ultrashort pulse fiber laser as defined in claim 1, wherein said linear dispersion compensator includes a pair of chirped fiber Bragg gratings with opposite sign dispersion optically coupled to said loop of optical fiber such that a net difference in dispersion between said first and second fiber Bragg gratings is substantially equal and opposite to dispersion generated in said loop of optical fiber.

3. The high energy, ultrashort pulse fiber laser as defined in claim 1, wherein said at least one chirped fiber Bragg grating is optically coupled to said loop of optical fiber by an optical circulator.

4. The high energy, ultrashort pulse fiber laser as defined in claim 1, wherein said pump light source is optically coupled to said loop of optical fiber by a wave division multiplexer.

5. The high energy, ultrashort pulse fiber laser as defined in claim 1, further comprising a polarization controller optically coupled to said loop of optical fiber for passively mode locking the optical fiber ring lasing cavity.

6. The high energy, ultrashort pulse fiber laser as defined in claim 2, wherein said linear dispersion compensator includes a tuner that stretches or compresses one of said pair of chirped fiber Bragg gratings to adjust said net difference in dispersion.

7. The high energy, ultrashort pulse fiber laser as defined in claim 1, wherein the dispersion of the loop of optical fiber is between about −40 ps/nm-km and −20 ps/nm-km.

8. The high energy, ultrashort pulse fiber laser as defined in claim 3, wherein said optical circulator is a four-port, polarization maintaining circulator.

9. The high energy, ultrashort pulse fiber laser as defined in claim 1, wherein said lasing dopant in said loop of optical fiber is a rare earth metal.

10. The high energy, ultrashort pulse fiber laser as defined in claim 9, wherein said lasing dopant is erbium.

11. A high energy, ultrashort pulse fiber laser, comprising:
a passively mode locked, all optical fiber laser including a loop optical fiber doped with a material that provides gain;
a pump light source optically coupled to said loop of optical fiber, and
a linear dispersion compensator including a pair of chirped Bragg gratings with opposite sign dispersion optically couples to said loop of optical fiber such that a net difference in dispersion between said pair of chirped Bragg gratings is substantially equal and opposite to dispersion generated in said loop of optical fiber.

12. A high energy, ultrashort pulse fiber laser as defined in claim 11, further comprising a polarization controller formed from a plurality of loops in said optical fiber for passively mode locking said all optical fiber laser.

13. A high energy, ultrashort pulse fiber laser as defined in claim 11, wherein said linear dispersion compensation further includes a four-part optical circulator for optically coupling the pair of chirped Bragg gratings to the finger ring lasing cavity.

14. A high energy, ultrashort pulse fiber laser as defined in claim 11, wherein said linear dispersion compensator includes a tuner for varying the bandwidth or the dispersion generated by at least one of the chirped Bragg gratings to adjust one of the net dispersion of the ring laser cavity and a third order dispersion of the cavity.

15. A high energy, ultrashort pulse fiber laser as defined in claim 14, wherein the tuner includes a mechanism for stretching and compression at least one of the chirped Bragg gratings.

16. A high energy, ultrashort pulse fiber laser as defined in claim 11, wherein the loop of optical fiber is a closed loop.

17. A high-energy, ultrashort pulse fiber laser as defined-in claim 11, wherein the doping material is a rare earth metal.

18. A high energy, ultrashort pulse fiber laser as defined in claim 17, wherein the doping material is one for the group consisting of erbium and yttrium.

19. A high energy, ultrashort pulse fiber laser as defined in claim 3, wherein said chirped fiber Bragg gratings are written in polarization maintaining or single polarization optical fiber.

20. A high energy, ultrashort pulse fiber laser as defined in claim 13, wherein the optical circulator is polarization maintaining.
